(19) United States
(12) Patent Application Publication
(10) Pub. No.: US 2008/0216753 A1
(43) Pub. Date: Sep. 11, 2008

(54) Pet feeding utensil

(75) Inventor: Chih-Sheng Wang, Taipei City (TW)

Correspondence Address: BUCKNAM AND ARCHER, 1077 NORTHERN BOULEVARD, ROSLYN, NY, 11576, US

(73) Assignee: Kuang-Huan Fu, Wu Jie Village (TW)

(21) Appl. No.: 11/787,717

(22) Filed: Apr. 17, 2007

(30) Foreign Application Priority Data
Mar. 8, 2007 (CN) 200710086411.7

(51) Int. Cl. A01K 5/01

(52) U.S. Cl. 119/61.1

(57) ABSTRACT

A pet feeding utensil is provided, comprising a main body having a receiving space, in which the bottom portion of the main body is combined with a footrest pad, the extended width of the footrest pad being the width of the inner diameter of the main body such that pet inevitably steps on it and the pet feeding utensil is fixed in place during eating. Further, a transparent member is inserted onto the main body so that a gap is formed between the transparent member and the receiving space to clip a picture concerned with pet education, such as a photograph of the master. In this manner, there is an opportunity of teaching the pet during eating so that intimate interaction between the pet and the master will be further enhanced.

### BACKGROUND OF THE INVENTION

1. Field of the Invention

This invention relates to a pet feeding utensil, more particularly to a pet feeding utensil having a footrest pad on which pet inevitably steps during eating and the pet feeding utensil is fixed in place by pet's own weight.

2. Brief Description of Prior Art

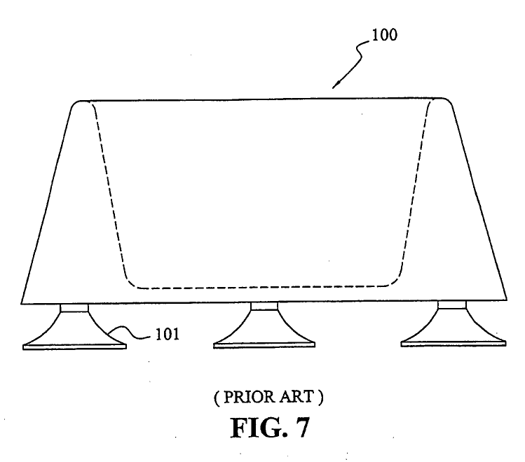

Generally, people having pet suffers the experience that the pet feeding utensil is not fixed in place, the utensil being pushed by the pet around even overturned by pet to cause perfusion of foods all over the floor. In order to improve this situation, the bottom portion of the conventional pet feeding utensil 100, as shown in FIG. 7, is enlarged to cause the stabilizing of grativity center of the utensil, and a plurality of suckers 101 are further provided beneath the bottom portion for sucking the ground. However, the people skilled in this art can understand that suckers 101 can only function well on flat and smooth floor, such as floor paved with tiles or on terrazzo, but ineffectively on grass or soil ground. Furthermore, suckers 101 can resist dragging force in vertical direction only, not in transverse direction. Thus, this conventional pet feeding utensil fails to solve the above problems.

### SUMMARY OF INVENTION

The object of the present invention is to provide a novel pet feeding utensil, which is aiming to improve the defects of conventional pet feeding utensil.

In order to achieve the above and other objects, the pet feeding utensil of the present invention comprises a main body having a receiving space, wherein the bottom portion of the main body is combined with a footrest pad, the extended width of the footrest pad being at least the width of the inner diameter of the main body such that pet inevitably steps on it during eating and the pet feeding utensil is fixed in place. In this manner, due to the fact the pet should come close to the main body of the feeding utensil during eating, the front limbs of pet is inevitably steps on the footrest pad and the pet feeding utensil is fixed in place by pet's own weight during eating.

According to the present invention, a transparent member is inserted onto the upper portion of the main body so that a gap is formed between the transparent member and the receiving space to clip a picture concerned with pet education, such as a photograph of the master. In this manner, there is an opportunity to teach the pet during eating so that intimate interaction between the pet and the master is further enhanced thereby.

### BRIEF DESCRIPTION OF PICTURES

The present invention will be further understood by the detailed description of the following embodiments in conjunction with the accompanied pictures, wherein:

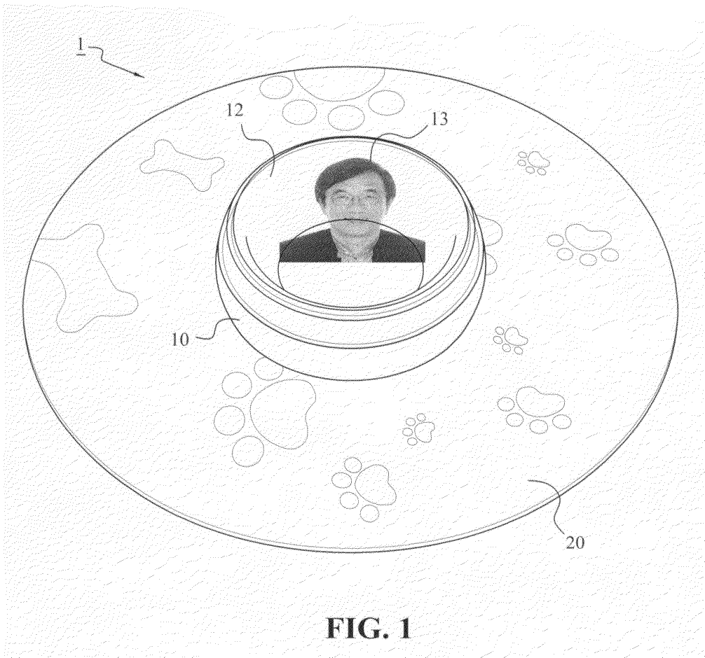

FIG. 1 is a schematic perspective view showing the pet feeding utensil of the first embodiment of the present invention.

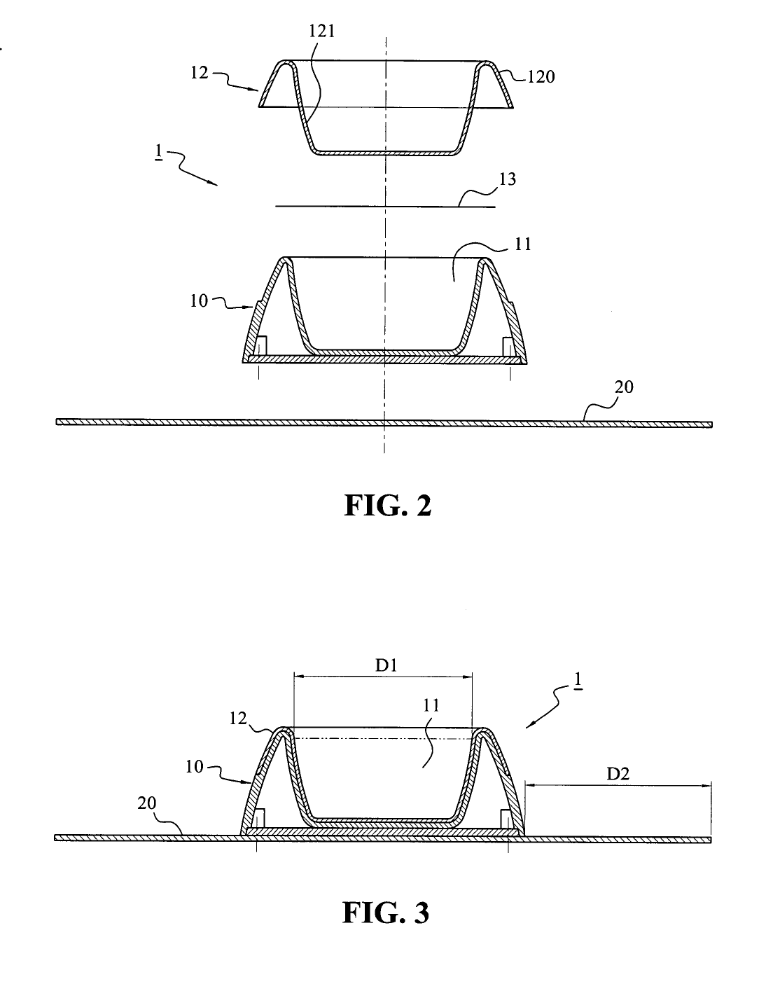

FIG. 2 is a schematic sectional view showing the detached status of the first embodiment of FIG. 1.

FIG. 3 is a schematic sectional view showing the assembly status of FIG. 2.

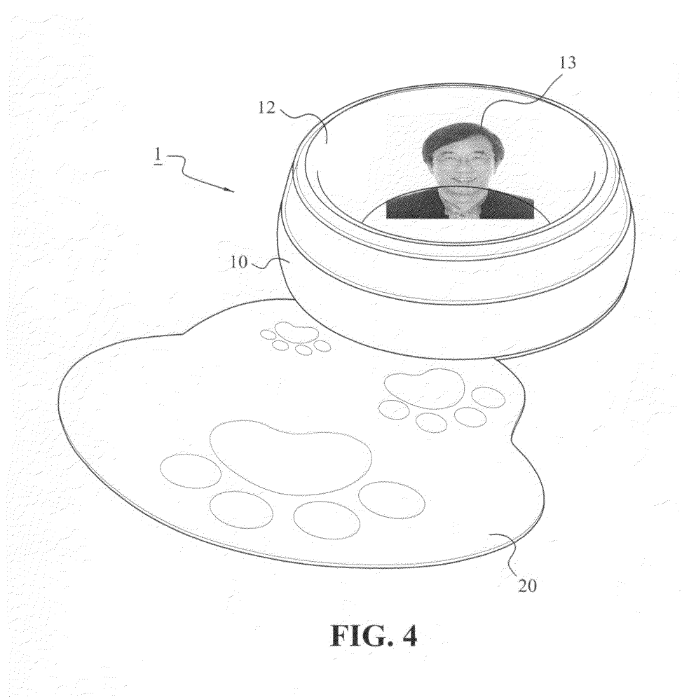

FIG. 4 is a schematic perspective view showing the pet feeding utensil of the second embodiment of the present invention.

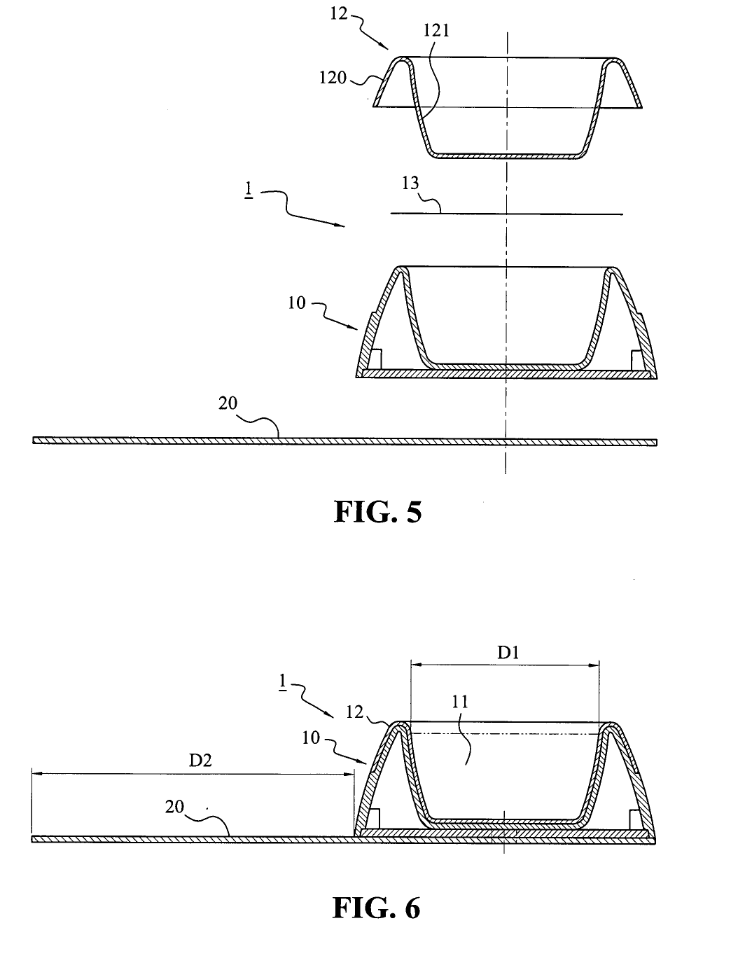

FIG. 5 is a schematic sectional view showing the detached status of the second embodiment of FIG. 4.

FIG. 6 is a schematic sectional view showing the assembly status of FIG. 5.

FIG. 7 is a schematic side view showing a conventional pet feeding utensil.

### DETAILED DESCRIPTION OF PREFERRED EMBODIMENTS

The technical features of the present invention will be better understood by further description of preferred embodiments of the present invention, which should not be considered as limitations to the scope of the present invention, in conjunction with the accompanied pictures.

Firstly, in FIG. 1 to FIG. 3, a pet feeding utensil of the first embodiment of the present invention is shown. The pet feeding utensil 1 of the present invention comprises a main body 10, which has a receiving space 11 for receiving foods etc. The bottom portion of the main body 10 is combined with a circular-shaped footrest pad 20, which extends outwardly in radial direction with the main body 10 as the center. Preferably, the width D2 extended outwardly by the footrest pad 20 from the bottom portion of the main body 10 is at least the width D1 of the inner diameter of the main body 10. The footrest pad 20 and the main body 10 can be fastened together by traditional method, such as high frequency hot welding, adhesive, or screw elements etc. Alternatively, The footrest pad 20 and the main body 10 can be detachably connected by any conventional retaining means (not shown) available.

In this manner, due to the fact the pet should come close to the main body 10 of the pet feeding utensil during eating, the front limbs of pet is inevitably steps on the footrest pad 20 and the pet feeding utensil is fixed in place by pet's own weight during eating. In addition, the footrest pad 20 in formed into circular shape, the above function can be achieved no matter whichever direction the pet accesses the main body 10.

FIG. 4 to FIG. 6 show the pet feeding utensil of the second embodiment of the present invention. This embodiment is basically the same in structure as the first embodiment, except the first embodiment is used in the place having abundant space. The difference of this embodiment with the above first embodiment is that the footrest pad 20 of this embodiment is designed into non-circular shape, i.e., the footrest pad 20 extends outwardly and radially in one direction from the bottom portion of the main body 10. The width D2 extended outwardly by the footrest pad 20 from the bottom portion of the main body 10 is at least equal to, preferably larger than the width D1 of the inner diameter of the main body 10. The footrest pad 20 and the main body 10 can be fastened together by traditional method, such as high frequency hot welding, adhesive, or screw elements etc. in such manner that the footrest pad 20 is combined in fixed direction with respect to the main body 10. Alternatively, The footrest pad 20 and the main body 10 can be detachably connected by any conventional retaining means (not shown) available, and the footrest pad 20 can be rotated to change direction with respect to the main body 10.

With this structure, the pet feeding utensil is positioned in such manner that the main body 10 is located oppositely to the access direction of pet, that is to say, the footrest pad 20 is positioned in the access direction of pet, or the pet feeding utensil is positioned in such a manner that the main body is at the corner of the house and the footrest pad 20 extends outwardly away from the corner of the house. Due to the fact the pet should come close to the main body 10 of the pet feeding utensil during eating, the front limbs of pet is inevitably steps on the footrest pad 20 and the pet feeding utensil is fixed in place by pet's own weight during eating.

In addition, a transparent member 12 is inserted onto the upper portion of the main body 10 such that the outer rim 120 of the transparent member 12 is encircling around the outside of the main body 10, the center portion of the transparent member 12 is a overlapped portion 121 laminated in the receiving space 11, and a gap is formed between the central portion of the transparent member 12 and the receiving space 11 of the main body 10. Thus, a picture 13 such as a photograph of the master, which has patterns concerned with pet education and is used to enhance the impression of pet for something, can be placed into the gap between the transparent member 12 and the receiving space 11. In this manner, there is an opportunity to teach the pet during eating so that intimate interaction between the pet and the master is further enhanced thereby.

So far, preferred embodiments have been described in conjunction with the accompanied drawings, however, this invention is not limited by those preferred embodiments. Modifications and equivalent variations made without departing from the spirit and scope of the present invention are still within the range of the present invention.

### SYMBOL LIST OF MAJOR COMPONENTS

1 pet feeding utensil
10 main body
11 receiving space
20 footrest pad
12 transparent member
13 picture

We claim:

1. A pet feeding utensil, comprising a main body having a receiving space, wherein the bottom portion of said main body is combined with a footrest pad extending outwardly in the radial direction, such that pet inevitably steps on it and the pet feeding utensil is fixed in place by pet's own weight during eating.

2. A pet feeding utensil as claimed in claim 1, wherein said footrest pad is in circular shape and extends outwardly and radially along the outer periphery of the bottom portion of said main body with the main body as the center.

3. A pet feeding utensil as claimed in claim 2, wherein the width extended outwardly of said footrest from said main body is at least equal to the width of inner diameter of the main body.

4. A pet feeding utensil as claimed in claim 3, wherein said footrest pad and said main body are fastened together by any one of high frequency hot welding, adhesive, or screw elements or retaining means etc.

5. A pet feeding utensil as claimed in claim 4, wherein said footrest pad and the bottom portion of said main body is detachably connected by retaining means.

6. A pet feeding utensil as claimed in claim 1, wherein said footrest pad extends outwardly and radially in one direction from the bottom portion of said main body.

7. A pet feeding utensil as claimed in claim 6, wherein the width extended outwardly by said footrest pad from the bottom portion of said main body is at least equal to the width of inner diameter of said main body.

8. A pet feeding utensil as claimed in claim 7, wherein the width extended outwardly by said footrest pad from the bottom portion of said main body is preferably larger than the width of inner diameter of said main body.

9. A pet feeding utensil as claimed in claim 8, wherein said footrest pad and the bottom portion of said main body are fastened together by any one of high frequency hot welding, adhesive, or screw elements or retaining means etc.

10. A pet feeding utensil as claimed in claim 9, wherein said footrest pad is combined in a fixed direction with respect to the main body.

11. A pet feeding utensil as claimed in claim 9, wherein said footrest pad and the bottom portion of said main body are detachably connected by retaining means.

12. A pet feeding utensil as claimed in claim 11, wherein said footrest pad can rotated to change direction with respect to said main body.

13. A pet feeding utensil as claimed in claim 1, wherein a transparent member is inserted onto the upper portion of said main body with the outer rim of said transparent member encircling around the outside of said main body, a gap being formed between the central portion of said transparent member and said receiving space.

14. A pet feeding utensil as claimed in claim 13, wherein a picture is placed into the gap formed between said transparent member and said receiving space.

15. A pet feeding utensil as claimed in claim 14, wherein said picture has patterns concerned with pet education.

16. A pet feeding utensil as claimed in claim 15, wherein said pattern is a photograph of the master of the pet.
